(19) United States
(12) Patent Application Publication
(10) Pub. No.: US 2004/0041787 A1
(43) Pub. Date: Mar. 4, 2004

(54) Method and apparatus for a hybrid pointing device used with a data processing system

(76) Inventor: Robert A. Graves, Kensington, MD (US)

Correspondence Address: VEDDER PRICE KAUFMAN & KAMMHOLZ, 222 N. LASALLE STREET, CHICAGO, IL, 60601, US

(21) Appl. No.: 10/230,002

(22) Filed: Aug. 28, 2002

(51) Int. Cl. G09G 5/08; G09G 5/00

(52) U.S. Cl. 345/157

(57) ABSTRACT

A system and method for combining the benefits of various isometric and/or anisometric mechanisms into a single pointing device are disclosed. The present invention relates to a hybrid pointing device, having a primary pointing device mechanism, such as a trackball, touch pad, or joystick, positioned conveniently on the housing of a base anisometric or isometric pointing device, such as a mouse, trackball, touch pad, or joystick, which function as a secondary pointing device mechanism. The hybrid pointing device performs different or identical functions within the context of, for example, gaming software, thus, in one embodiment combining the accuracy of the mouse with the functionality of joysticks.

### BACKGROUND OF THE INVENTION

Data processing systems (FIG. 1) use keyboards 102 and visual monitors 106 to provide a generic interface between users and system hardware. Basic-input-output-software (i.e., BIOS) and operating systems (e.g., WINDOWS, LINUX, UNIX) provide a software-based interface between the system hardware and software applications running on that hardware. With the proliferation of operating systems using graphical user interfaces, pointing devices 104 are used to supplement the traditional keyboard 102 as a means of input into a system. Under some circumstances, pointing devices 104 can actually replace the keyboard 102 as the preferred means of input into a system. As new software products are developed, the need for pointing devices 104 having more robust and/or flexible features has evolved. The structure and function of computers has changed over time and pointing devices 104 have been developed to accommodate these structural and functional adaptations. Moreover, as hardware and software has become a commonplace, household item of manufacture, new pointing device designs have addressed the needs of individual users, such as the disabled.

Pointing devices fall generally into two categories: isometric and anisometric. Isometric pointing devices are those that provide an infinite resistance to movement (i.e., they are themselves motionless and operate based on pressure detection). Anisometric pointing devices are those that operate based on displacement. That is, anisometric pointing devices effect on-screen movement by a corresponding movement of the pointing device itself. There are four categories of anisometric pointing devices: isotonic, elastic, viscous, and inertial. Isotonic pointing devices have a constant (e.g., zero) resistance to movement, elastic pointing devices have a resistance proportional to physical displacement from a predetermined point. Viscous pointing devices have a resistance proportional to the velocity of movement. Finally, inertial pointing devices have a resistance proportional to the acceleration of movement. Otherwise identical anisometric pointing devices may fall under different categories by way of small changes in the hardware that are well known in the relevant art.

Examples of anisometric pointing devices include the mouse (FIG. 2; see, e.g., Lapson, et al.; U.S. Pat. No. 4,464,652), trackball (FIG. 3; see, e.g., Luque; U.S. Pat. No. 4,538,476), joystick (FIG. 5; see, e.g., Aamoth, et al.; U.S. Pat. No. 4,124,787), and touch pad (FIG. 4; see, e.g., Wolfe, et al.; U.S. Pat. No. 6,037,930). With respect to FIG. 2, a mouse 200 generally includes a housing 202 that is moved across a (preferably smooth) surface (not shown). A cursor (not shown), displayed on the visual monitor of a data processing systems screen moves in response to the movement of the mouse 200. The two most common ways to represent movement of the mouse as movement of the cursor include: 1) tracking the movement of a sphere 248 operatively connected to the bottom (not shown) of the mouse 200 such that the sphere 248 is in contact with the surface over which the mouse 200 is moved, or 2) using a optical device, which records pictures of the surface over which the mouse 200 is moved at very frequent intervals and calculating vector displacement (i.e., changes in distance and speed) based on the differences between the pictures. Movement of the sphere 248 is tracked by two rotatable shafts (not shown) that are normally disposed and contact the sphere 248. Each shaft is coupled to a slotted wheels (not shown). Each wheel is positioned between two light-emitting diodes (i.e., LED's) (not shown) and two photocells (not shown). When a light beam (not shown) from each LED shines through one of the slots, the light beam causes the photocell on the other side of the wheel to generate a small amount of current. When the slotted wheel moves slightly, it blocks the light beam and the photocell doesn't generate much, if any, current. When the shaft moves, the slotted wheel moves, and the moving slots repeatedly break the light beam shining on the photocell. This causes the photocell to generate rapid pulses of current. Based on the frequency of pulses generated by the photocells, the data processing system interprets the movement and speed of such movement of the sphere 248 and the mouse 200. The mouse 200 has a communication means 208 to send a control signal (not shown) to the data processing system.

With respect to FIG. 3, a trackball 300 acts as a mouse which has been turned upside-down. The sphere 348 is disposed on the top or side surface of the housing 302 of the device. Instead of rolling a trackball 300 across a surface, a user's palm or one or more of a user's digits moves the sphere 348. A device similar to that described above with respect to the mouse translates that movement into commands for the on-screen cursor. The trackball 300 has a communication means 308 to send a control signal (not shown) to the data processing system.

Trackballs and mice are the preferred pointing devices for productivity tools such as word processors, spreadsheets, and the like, and represent the most accurate means of placing a cursor in a particular on-screen position. However, in the field of computer gaming, both trackballs and mice have their shortcomings. For example, if a mouse were to provide movement commands for an on-screen character in a game, the mouse would have to be moved constantly over larger distances than the user's desktop, or the length of the user's arm, is likely to provide. The only other option available would be to move the mouse, lift it, return it to its original position, and then repeat the process. Because many video games are “real-time,” requiring immediate response on the part of the user, the mouse is ill-suited to provide this functionality in the gaming environment. The trackball requires a continual resetting of the enabling potion of the user's body (i.e., palm, finger, or thumb used to rotate the trackball's sphere) in order to continually move the character.

Anisometric joysticks (FIG. 5) were developed primarily for their suitability for playing video games. With respect to FIG. 5, an anisometric joystick 500, a vertical stick 552 is connected to a base 502, such that in the vertical stick 552 can be moved and disposed any orientation within a virtual cone about the coupling 548. In an analog anisometric joystick, the coupling 548 consists of two potentiometers (not shown) with variable resistance values between a lower and upper bound. The potentiometer resistances have the minimum values when the joystick is disposed in the top left position. Thus, when the value of the resistances in the potentiometers is transmitted to a data processing system, the data processing system will translate those values to, for example, movement commands in a game corresponding to the direction in which the vertical stick 552 is disposed. A problem with analog joysticks is that the host computer must dedicate excessive processing power to regularly “poll” the joystick system to determine the position of the vertical stick 552, which consumes a lot of power that could otherwise be spent on other operations. Joystick manufacturers have addressed these problems in two different ways. One solution is to add a sensitive analog-to-digital converter chip (not shown) in a specialized game adapter card or in the joystick itself. In this system, the analog-to-digital converter chip actively transmits digital information directly to the data processing system, which improves the accuracy of the anisometric joystick 500 and reduces the work load on the data processing system. Another solution is to replace analog potentiometer technology with a mechanism to read vertical stick 552 movement digitally. Such a mechanism uses optical sensors (not shown), slotted wheels (not shown), LED's (not shown), and photocells (not shown) that operate in much the same way as mouse technology described with respect to FIG. 2.

If held in an off-center position for more than an instant, the joystick 500 will continuously send a command to the data processing system. For example, if the anisometric joystick 500 is mapped to provide movement commands for an on-screen character in a game, then moving and holding the anisometric joystick 500 in a forward position will continuously send a forward motion command to the data processing system for the character controlled by the anisometric joystick 500. The anisometric joystick 500 also has the advantage of detecting the degree to which the user is moving the anisometric joystick 500 in a particular direction. A user might move the anisometric joystick 500 forward slightly to move the character forward slowly or move the joystick 500 to its farthest position to move the character forward quickly. Also, an anisometric joystick 500 can detect if the user desires movement at any angle, while the keyboard and directional pad (q.v.) offer movement only along normally oriented x and y axes (forward, reverse, left and right) and a pair normally oriented axes disposed rotated 45 degrees from the x and y axes (diagonal motion). In addition, the joystick 500 can be depressed to act as a button. Unfortunately, although this functionality is often important, the nature of an anisometric joystick 500 is such that it is less precise than a mouse or trackball, and is very difficult to use with the productivity software mentioned above. The anisometric joystick 500 has a communication means 508 to send a control signal (not shown) to the data processing system.

With respect to FIG. 4, touch pads 402 are touch-sensitive areas designed to send commands to the data processing system 400 by way of a user dragging a finger or object across a sensitive surface 404 of the touch pad 402 or touching it at a particular point. Touch pads 402 were developed to provide a low-power consuming pointing device that provides more control than the joystick without the need for large amounts of table space required of a mouse. Moreover, the touch pad 402 is encased within the housing 408 of the data processing system 400 itself, lessening the probability of accidental damage done to the device. In order to permit selection of an object on a visual display monitor 450, at least one button 414a is provided, with at least one other button 414b customarily provided as well. Unfortunately, the small amount of space provided by a touch pad 402 makes such a pointing device unsuitable for gaming and other real-time applications, requiring the same recurring return to an original position described with respect to the mouse and, more particularly, the trackball in FIGS. 2 and 3 above. Moreover, touch pads 402 often receive errant signals from accidental contact by the user, sending a cursor to an undesired position on screen. When typing a sentence in a word processing program, for example, in mid-sentence the cursor may jump to another part of the screen, placing part of a sentence being typed into another part of a word processing document.

Examples of features added to these traditional pointing devices are the button, the wheel, the slider, and the directional pad (a.k.a., D-Pad, POV Hat). Returning to FIGS. 2 and 3, even the most basic mice 200 and trackballs 300 include at least one button 204a, 204b, 304a, 304b, 304c which is used to select elements on the graphical user interface of the data processing system. Buttons 204a, 204b, 304a, 304b, 304c can usually be clicked or double-clicked, with a different function applied to each method. Moreover, the particular function mapped to a button 204a, 204b, 304a, 304b, 304c may be modified by the user. Returning to FIG. 5, on a joystick 500, buttons 504a, 504b, 504c generally support only a single-click method, but it is very common to have a plurality of buttons 504a, 504b, 504c on ajoystick 500, each mapped to a different function.

Returning to FIG. 2, some mice 200 (and trackballs) further add a scroll wheel 206 between the buttons 204a, 204b present on the top surface of the housing 202. As the scroll wheel 206 is turned, the user feels resistance against turning the scroll wheel 206 as a plurality of knobs (not shown) makes contact, one after the other, with a spring (not shown); which is followed by a release of that resistance (as the contact is broken). The sensation of the increase and decrease in resistance allows the user to determine how much the user has turned the scroll wheel 206. Moreover, the scroll wheel 206 may support a depression method such that the scroll wheel 206 acts as an additional mouse button. Internally, the scroll wheel 206 is a wheel with spokes (not shown), which is supported by rotatable supports (not shown). As the scroll wheel 206 is turned, a beam (not shown) from a laser (not shown) is blocked from a receiving sensor (not shown). The blocking and unblocking of the beam indicates that the scroll wheel 206 is being turned, and the frequency of the blocking and unblocking indicates the speed of the rotation. Unfortunately, the scroll wheel 206 is suitable only for movement in a single degree of freedom, and is used to position the viewable area of a document along the same axes as the mouse 200 itself. Thus, for example, in a word processing document that is larger than what is presented on a display screen, there are two scroll bars (not shown) allowing for scrolling along the X and Y axes (not shown). Movement of the mouse 200 across a desktop provides cursor movement along those X and Y axes, whereas the scroll wheel 206 permits scrolling along the Y-axis (i.e., one of the two axes along which the cursor is moved). Returning to FIG. 5, another optional control mechanism is the slider 506a, 506b, which can take the form of a wheel or a physical slide. Sliders 506a, 506b sometimes appear on the base 502 of the joystick 500, and operate in the same manner (with the same limitations) as the joystick 500, but use a single potentiometer because they operate with only a single degree of freedom. Sliders 506a, 506b are not capable of acting as a button 504a, 504b, 504c.

A directional pad 554 is a group of four on-off switches. Each switch could be programmed to equate to any key on the keyboard attached to the data processing system. Thus, if the game was already configured with the “WASD” configuration (i.e., using the W, A, S, D, or other keyboard keys to control movement within a game), the directional pad 554 could be mapped to virtually press W, A, S, or D for the user (or the combinations WA, WD, SA, or SD). SAITEK of Hong Kong has developed a mouse with a directional pad positioned for easy access using a thumb sold under the brand name GM1 Scroll Mouse. Numerous joysticks 500 also employ the directional pad 554, mapping its functions to a game character's choice of point of view. The disadvantage, however, is the same as a keyboard's limitation: a switch is either pressed or not. There is no degree to which the switch is pressed to indicate slower versus faster movement.

Returning to FIG. 4, an example of an isometric device is the isometric joystick 410 (see, e.g., Engle, et al., U.S. Pat. No. 5,889,507). Isometric joysticks 410 are represented by a short, pressure sensitive stick 410 that provides similar functionality, but are much more sensitive than anisometric joysticks being that their operation is based on pressure detection. The primary use of the isometric joystick has been on portable laptop computers 400, whose requirements of portability often result in a lack of available table space, precluding the use of mice. Because of its sensitivity, the isometric joystick 410 is well suited for use by the disabled (who have limited capacity for movement) or where such a device is integrated into a physically small area, such as a laptop computer keyboard 448 or between the buttons of, for example, a mouse. In order to permit selection of an object on a visual display monitor 450, at least one button 412a is provided, with at least one other button 412b customarily provided as well.

In order to overcome the disadvantages associated with individual pointing devices, systems and methods have been developed for using two pointing devices simultaneously. For example, Kandogan, et al. (U.S. Pat. No. 6,184,867 Bi) discloses an input for three-dimensional navigation using two isometric joysticks. Physical limitations of the pointing devices prevent more than a relatively small number of buttons on the housing. Accordingly, complex games allow user interaction by way of the keyboard to supplement or substitute for the commands sent by the pointing device. However, devices, such as described in Kandogan, prevent the effective use of a keyboard for performing one of many important but only occasionally needed functions (e.g., changing weapons), and use two isometric joysticks to manipulate the same visual perspective in a graphical user interface. Devices such as Kandogan are closely related to the now antiquated, coin-operated arcade game user input boards, in which, for example, a trackball roller could be operated with one hand while a small number of buttons could be pressed by the other hand. Arcade game user input boards were not intended to be used with a keyboard, in part because the number of controls necessary were fewer in number, and in part because each board was custom tailored for a single game. Thus, these devices do not provide the necessary flexibility for today's gaming industry.

As another alternative, various two-handed and combination devices have been developed. For example, as illustrated in FIG. 6, the game pad 600 was developed for data processing systems dedicated specifically to gaming, such as the X-BOX™ from MICROSOFT CORP. Game pads 600 have a housing 602 that is suited for two handed use. The controls on a game pad 600, which are positioned in a manner also suited for two handed use, are generally controlled with the user's thumbs and index fingers. This is an interesting development because, on a computer, the user's thumbs are almost never used except to hit the space bar on a keyboard (which most game-players use to initiate a “jump” for an on-screen character). Most game pads 600 now come with two joysticks 610, 620, one for each thumb, and a directional pad 654 controlled by the user's left thumb. Additionally, a game pad 600 will have at least one button 604a, 604b, 604c. Game pads 600 are intuitive, easy to learn and use, and very durable. They have two major disadvantages when used with data processing systems: the joysticks 610, 620 are not as accurate as the mouse; and, as with the use of multiple controllers, game pads 600 prevent the effective use of a keyboard for performing other functions.

Yet another attempt to overcome the disadvantages of prior art pointing devices is the use of an isometric joystick or a trackball roller in place of the scroll wheel on a mouse. IBM CORPORATION of Armonk, N.Y., has developed the SCROLL POINT® mouse, which places an isometric joystick where the scroll wheel would ordinary be placed. Similarly, the WEB CRUISER™ mouse from IOGEAR of Irvine, Calif. places a trackball roller where the scroll wheel would ordinary be placed. Both devices permit scrolling along both the X and Y axes, but do not permit manipulation of different perspectives within the visual interface of the data processing system (i.e., manipulation along the Z axis or rotation around the X, Y, or Z axes).

Therefore, the need exists in the art for a device that addresses the disadvantages of the prior art devices addressed above.

### BRIEF DESCRIPTION OF THE DRAWINGS

In the course of this detailed description, the reference will frequently be made to the attached drawings in which:

FIG. 1 is a view of a known data processing system;

FIG. 2 is a perspective view of a known mouse-type pointing device with two buttons and a scroll wheel;

FIG. 3 is a perspective view of a known trackball-type pointing device with three buttons;

FIG. 4 is a view of a known laptop data processing system with an isometric joysticktype pointing device embedded in a keyboard and a touch pad-type pointing device;

FIG. 5 is a perspective view of a known anisometric joystick-type pointing device;

FIG. 6 is a perspective view of a known game pad (specifically, the X-BOX game pad by MICROSOFT);

FIG. 7 is a perspective view of a mouse-type pointing device with an anisometric joystick attached to a side surface of the housing;

FIG. 8 is a side view of a mouse-type pointing device with an anisometric joystick attached to a side surface of a heightened housing;

FIG. 9 is a perspective view of a mouse-type pointing device with two anisometric joysticks on each side, and a widened housing;

FIG. 10 is a perspective view of a mouse-type pointing device with an anisometric joystick attached to the top surface of the housing;

FIG. 11 is a cutaway, internal view of a mouse-type pointing device with an anisometric joystick attached to a side surface of the housing;

FIG. 12 is a perspective view of a trackball-type pointing device with an anisometric joystick attached to a side surface of the housing;

FIG. 13 is a perspective view of a trackball-type pointing device with a touch pad attached to the top surface of the housing;

FIG. 14 is a perspective view of a trackball-type pointing device with a second trackball-roller attached to a side surface of the housing;

FIG. 15 is a perspective view of an anisometric joystick-type pointing device with a trackball-roller attached to the topmost surface of the housing;

FIG. 16 is a perspective view of an anisometric joystick-type pointing device with a touch pad attached to the topmost surface of the housing;

FIG. 17 is a perspective view of a trackball-type pointing device with an isometric joystick attached to the top surface of the housing;

FIG. 18 is a perspective view of a touch pad-type pointing device with an isometric joystick attached to the top surface of the housing;

FIG. 19 is a perspective view of an isometric joystick-type pointing device with a mouse-type pointing device attached to the topmost surface of the housing; and

FIG. 20 is a perspective view of an isometric joystick-type pointing device with a second isometric joystick attached to the topmost surface of the housing

FIG. 21 is a flowchart illustrating the generation, processing, and transmission of control signals from the hybrid pointing device; and

FIG. 22 is a flowchart illustrating an alternate method for the generation, processing, and transmission of control signals from the hybrid pointing device.

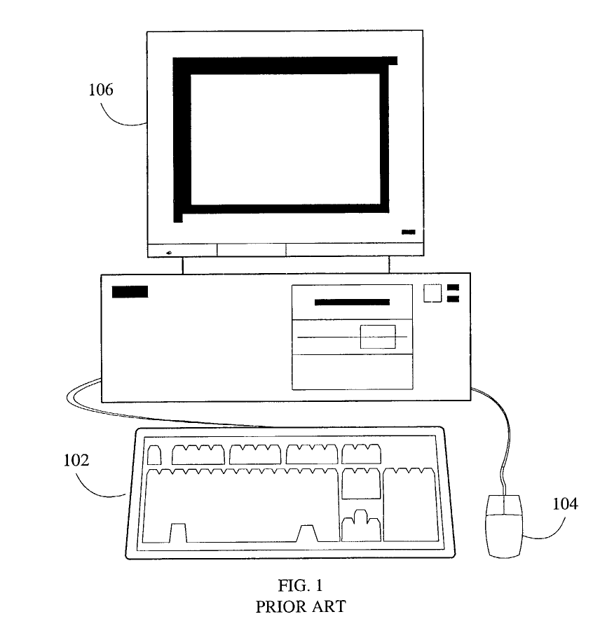

### DETAILED DESCRIPTION OF THE PREFERRED EMBODIMENTS

The present invention is directed to an improved system and method combining the benefits of various isometric and/or anisometric mechanisms into a single pointing device. A hybrid pointing device has a housing and base pointing device mechanism similar to that of a prior art pointing device, but also uses a secondary pointing device mechanism that typically would be used as a primary pointing device mechanism. The mechanisms may be used to control separate functions, methods, perspectives, elements, or other characteristics of a visual display well known in the relevant art. The base and secondary mechanisms can each take the form of either an isometric pointing device, such as an isometric joystick; or an anisometric pointing device, such as a mouse, trackball, touch pad, or anisometric joystick. The secondary mechanism is positioned conveniently on the housing of a base pointing device so as to combine the advantages of the mechanisms and/or the combination of the mechanisms. To facilitate such a combination of mechanisms, the size of the pointing device housing may be changed. Moreover, any means of communication well known in the art can be used to send, simultaneously or individually, control signals (in any format well known in the art) from the pointing device mechanism to a data processing system, which may additionally contain a filter driver.

### Base Anisometric, Secondary Anisometric

In one embodiment of the present invention, an anisometric pointing device has a housing with a plurality of surfaces which includes at least a top surface and a bottom surface, but may also have at least one side surface, a topmost surface, and at least one upper side surface. The anisometric pointing device has a first anisometric mechanism for generating a first control signal. Moreover, the device includes at least a second anisometric pointing device mechanism for generating at least a second control signal. The first and the at least the second anisometric mechanisms can the same or different, and each can be used to manipulate different perspectives within the visual interface of the data processing system. For example, the first anisometric pointing device mechanism can be used to control lateral movement in an XYZ space (i.e., forward, backward, left, right, up, or down movement), whereas the second anisometric pointing device mechanism can be used to control rotational movement in XYZ space (i.e., pitch, yaw, or roll). Alternatively, the first and the at least a second anisometric mechanisms can be used to manipulate perspectives for different elements within the visual interface of the data processing system. For example, the first anisometric pointing device mechanism can be used to control targeting of a game character's weapon in an XYZ space, whereas the second anisometric pointing device mechanism can be used to control movement of the character itself in XYZ space. Where appropriate, the positioning of the at least a second anisometric pointing device mechanism and the physical size of the housing can be such that the anisometric pointing device can be operated by a single hand of the user. For example, the at least a second anisometric pointing device mechanism can be placed on the top of the housing next to the buttons that would be used by the user's index, middle, and ring fingers, permitting one or more of those fingers to most easily manipulate that mechanism. In the alternative, the at least a second anisometric pointing device mechanism can be placed on a side surface such that the user's thumb or little finger can most easily manipulate that mechanism. Moreover, the least a second anisometric mechanism may be included to actuate a switch, for example, pushing down on the top surface of the at least the second anisometric pointing device mechanism has the same effect as pushing a button, providing for yet another functionality that otherwise would not have been available on the anisometric pointing device.

The anisometric pointing device has a communication means for transmitting at least one of the first control signal and the at least a second control signal to a data processing system on which a software application is running. Thus, the anisometric pointing device can be used to input control signals to the software application. The communication means can be a cable, wireless interface, or any means well known in the relevant art. Moreover, the format of the communication protocol can be serial, parallel, USB, PS/2, firewire, or any format well known in the relevant art. The communication means may combine the first control signal and the at least a second control signal into an integrated control signal prior to our subsequent to transmission from the anisometric pointing device if such an integrated control signal is desirable. The integrated control signal can have a structure such that its component control signals maintain their individuality, or alternatively lose that individuality, for example, for processing by a common driver that recognizes only the integrated control signal.

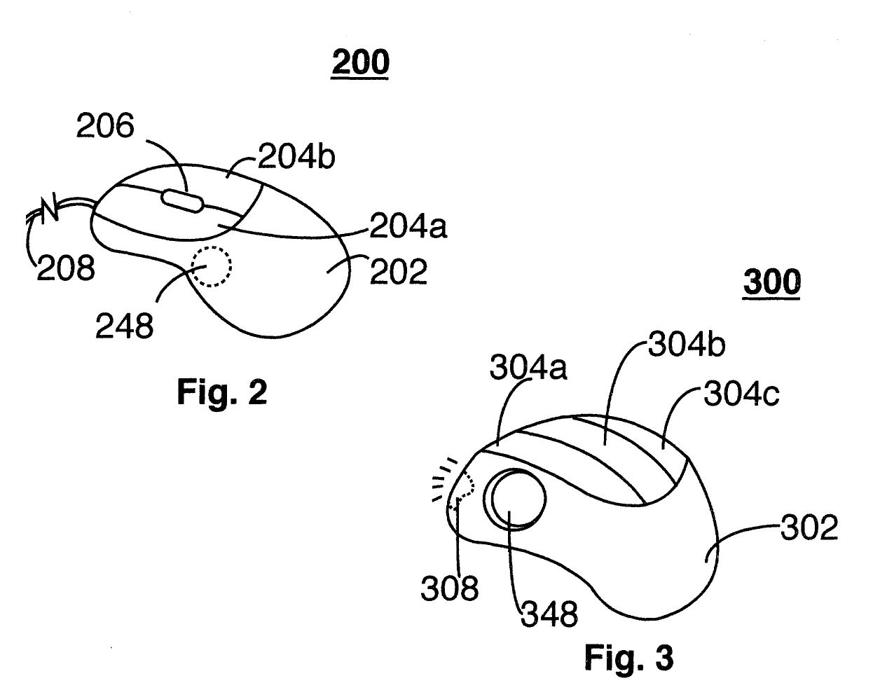

FIG. 7 is a perspective view of an anisometric pointing device 700 in accordance with the principles of one embodiment of the present invention. The base pointing device mechanism 748 is a sphere as described with respect to a conventional mouse illustrated in FIG. 2. Also, as with conventional mice, the anisometric pointing device 700 includes a housing 702; at least one button, with the example illustrated showing two buttons 704a, 704b; a scroll wheel 706, and a communication means 708 to send a control signal (not shown) to the data processing system. As illustrated in the embodiment of FIG. 7, the communication means 708 preferably is a cable suitable for transmitting the signal in a USB format. The anisometric pointing device 700 further includes a secondary pointing device mechanism 710, which, as illustrated in the example embodiment of FIG. 7, is an anisometric joystick. The secondary pointing device mechanism 710 has a stem 712 coupled to the thumb side surface at a coupling 714. The coupling 714 is designed such that the secondary pointing device mechanism 710 has the ability to be moved in any direction on an XY plane defined by the surface to which the stem 712 is connected. The coupling 714 may also be designed to support movement to actuate a switch, for example, pushing along the axis defined by the stem 712 has the same effect as pushing a button. This movement can be mapped to duplicate pushing of a mouse button, but will preferably be mapped to a unique function, increasing the functionality of the anisometric pointing device 700 in general. The secondary pointing device mechanism 710 also has a contact portion 716 where the user's manipulating digit customarily makes contact when manipulating the secondary pointing device mechanism 710. The contact portion 716 can be flat, recessed, or raised to facilitate user comfort and/or friction between the user's manipulating digit and the contact portion 716 during operation.

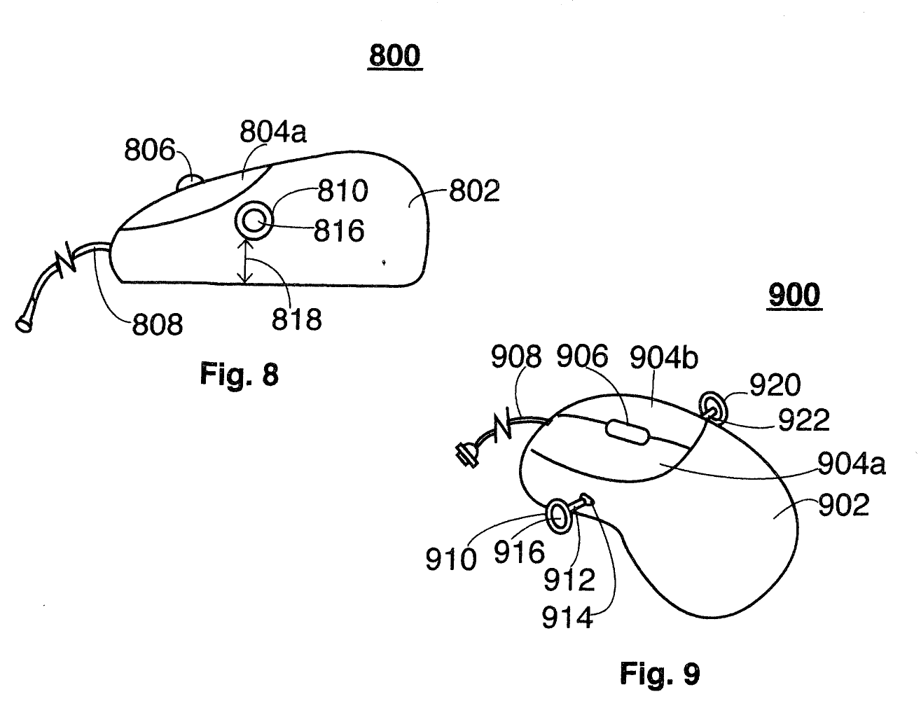

FIG. 8 is a side view of an anisometric pointing device 800 of the same type (i.e., mouse) as illustrated in FIG. 7. Accordingly, the anisometric pointing device 800 has a housing 802, a button 804a, a scroll wheel 806, a communication means 808, which, as illustrated, is preferably a cable suitable for transmitting the signal in a USB format, and a secondary pointing device mechanism 810 comprising, among other things, a contact portion 816. The housing 802 is designed such that the entire anisometric pointing device 800 is higher than a standard mouse. As such, the distance 818 between the bottom surface of the mouse and the lowest point of the secondary pointing device mechanism 810 is high enough to easily facilitate full range of motion for the secondary pointing device mechanism 810.

FIG. 9 is a perspective view of an anisometric pointing device 900 of the same type (i.e., mouse) as illustrated in FIG. 7. Accordingly, the anisometric pointing device 900 has a housing 902, a plurality of buttons 904a, 904b, a scroll wheel 906, a communication means 908, which, as illustrated, is preferably a cable suitable for transmitting the signal in serial format, and a secondary pointing device mechanism 910 comprising a stem 912, a coupling 914 of the stem 912 to the thumb side surface of the housing 902, and a contact portion 916. Moreover, a tertiary pointing device mechanism 920 is present, which comprises, among other things, a stem 922 coupled to the little finger side surface, for a right-handed user of the housing 902 at a second coupling (not shown), and a contact portion (not shown). The housing 902 is designed such that the entire anisometric pointing device 900 is wider than a standard mouse, facilitating attachment construction of a mouse having a secondary 910 and tertiary 920 pointing device mechanism, and appropriate electronics (not shown) attached.

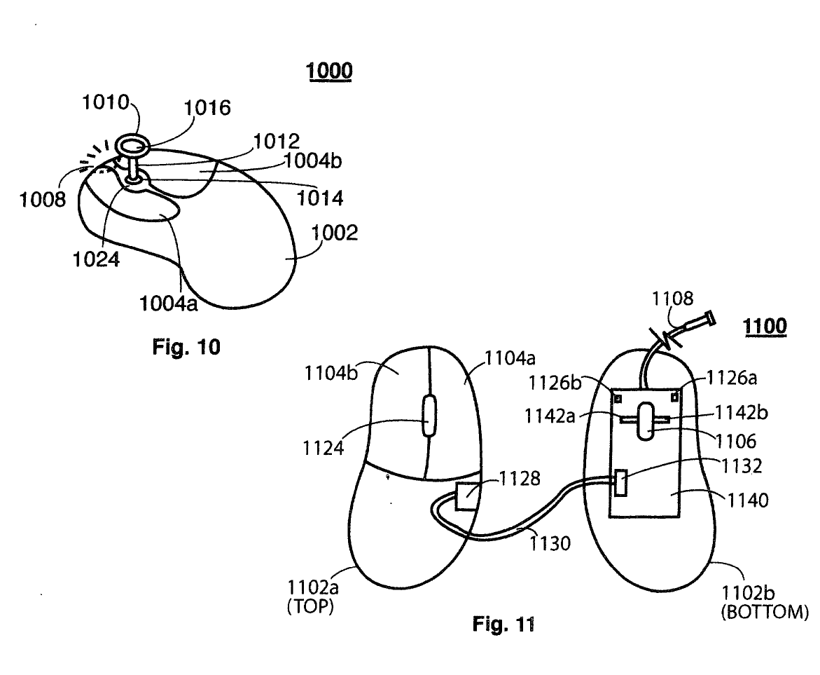

FIG. 10 is a perspective view of an anisometric pointing device 1000 of the same type (i.e., mouse) as illustrated in FIG. 7. Accordingly, the anisometric pointing device 1000 has a housing 1002, a plurality of buttons 1004a, 1004b, a communication means 1008, which as illustrated, is preferably a wireless interface suitable for transmitting the signal in USB format, and a secondary pointing device mechanism 1010 comprising a stem 1012, a coupling 1014 of the stem 1012 to the top surface of the housing 1002, and a contact portion 1016. Absent from this embodiment of the present invention is a scroll wheel, which has been replaced by the secondary pointing device mechanism 1010. To facilitate connection of the secondary pointing device mechanism 1010, the top surface of the housing 1002 contains a stable portion 1024 that separates the buttons 1004a, 1004b and provides a suitable place for the coupling 1014.

FIG. 11 is a cutaway view of an anisometric pointing device 1100 similar to the embodiment illustrated in FIG. 7. The housing has been separated into a top housing portion 1102a and a bottom housing portion 1102b and positioned so that the view shows the interior of both. The top housing portion 1102a contains two buttons 1104a, 1104b and an opening 1124 through which a scroll wheel 1106 will protrude when the top housing portion 1102a and the bottom housing portion 1102b are properly connected. Attached to the interior of the top housing portion 1102a is a secondary printed circuit board (“PCB”) 1128. Because the operation and construction of the secondary PCB 1128 is well known in the relevant art, the discussion here is related only to the novel principles of the embodiments of the present invention. In particular, the secondary PCB 1128 contains control circuitry for, and is accordingly coupled to, at least a second secondary anisometric pointing device mechanism (not shown) to effectuate the functionality of the at least a second secondary anisometric pointing device mechanism. The secondary PCB 1128 is also coupled—typically by soldering—to an internal communication means 1130, which as illustrated is a wire; however, any means of communication well known in the relevant art may be used, such as, for example a wireless communication means. In another embodiment of the present invention, the secondary PCB 1128 could be integrated into the PCB 1140. In such an embodiment, the at least a second anisometric pointing device mechanism 1120 would be connected directly to the internal communication means 1130.

The internal communication means 1130 is also coupled to a plastic connector 1132, which rests upon an (otherwise standard) PCB 1140 for an at least a second anisometric pointing device mechanism 1120. The plastic connector is designed such that the signals received from the internal communication means 1130 are routed to the proper connections on the PCB 1140. Because the operation and construction of the PCB 1140 is well known in the relevant art, it is discussed only briefly here. The PCB 1140 comprises, among other things, a corresponding button response mechanism 1126a, 1126b for each button 1104a, 1104b attached to the top housing portion 1102a. Upon movement of a button 1104a, 1104b, the corresponding button response mechanism 1126a, 1126b is activated, sending the appropriate control signal to a data processing system by way of a communication means 1108. As illustrated in the example embodiment of FIG. 11, the communication means 1108 takes the form of a cable suitable for transmitting the signal in a USB format. Upon the PCB 1140 rests a plurality of rotatable supports 1142a, 1142b, which themselves support the scroll wheel 1106.

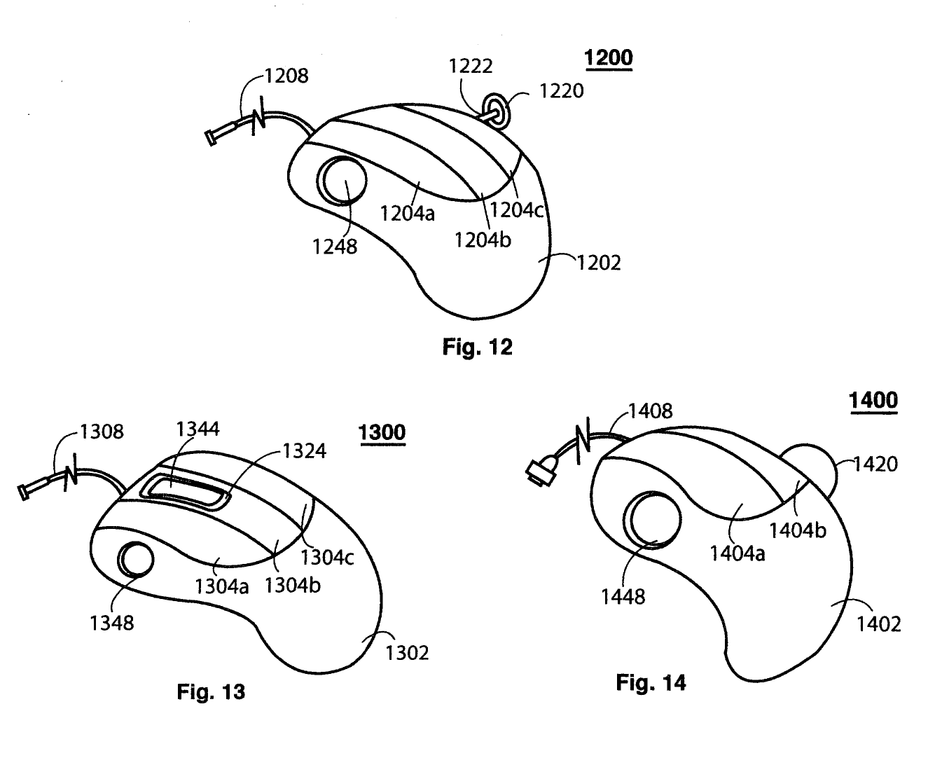

FIG. 12 is a perspective view of another anisometric pointing device 1200 in accordance with the principles of the present invention. A base pointing device mechanism 1248 is a sphere as described above with respect to a conventional trackball illustrated in FIG. 3. As illustrated, the base pointing device mechanism 1248 is coupled to a thumb side surface of the housing 1202. Also, as with generic trackballs, the anisometric pointing device 1200 includes at least one button, with the example illustrated showing three buttons 1204a, 1204b, 1204c; and a communication means 1208 to send a control signal (not shown) to the data processing system. As illustrated in the embodiment of FIG. 12, the communication means 1208 is preferably a cable suitable for transmitting the signal in a USB format. The anisometric pointing device 1200 further includes a secondary pointing device mechanism 1220, which, as illustrated in the embodiment of FIG. 12, is an anisometric joystick. The secondary pointing device mechanism 1220 has a stem 1222 coupled to the little finger side surface, for a right-handed user, at a coupling (not shown). The coupling is designed such that the secondary pointing device mechanism 1220 has the ability to be moved in any direction on an XY plane defined by the surface to which the stem 1222 is coupled. The coupling may also be designed to support movement to actuate a switch. For example, pushing along the axis defined by the stem 1222 has the same effect as pushing a button. This movement can be mapped to duplicate pushing of another trackball button, but will preferably be mapped to a unique function, increasing the versatility of the anisometric pointing device 1200 in general. The secondary pointing device mechanism 1220 also has a contact portion (not shown) where the user's manipulating digit customarily makes contact when manipulating the secondary pointing device mechanism 1220. The contact portion can be flat, recessed, or raised to facilitate user comfort and/or friction between the user's manipulating digit and the contact portion during operation.

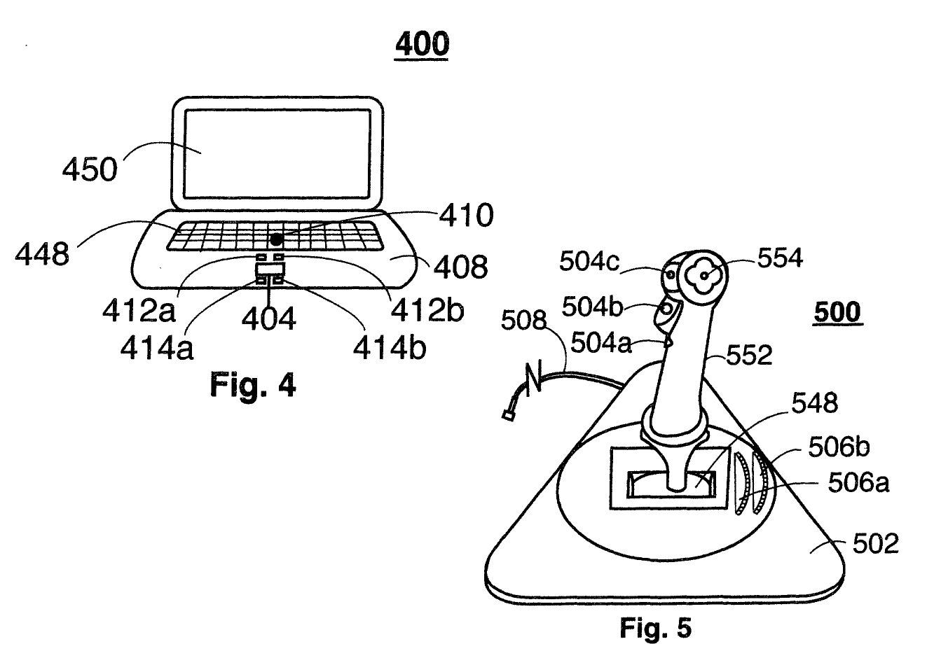

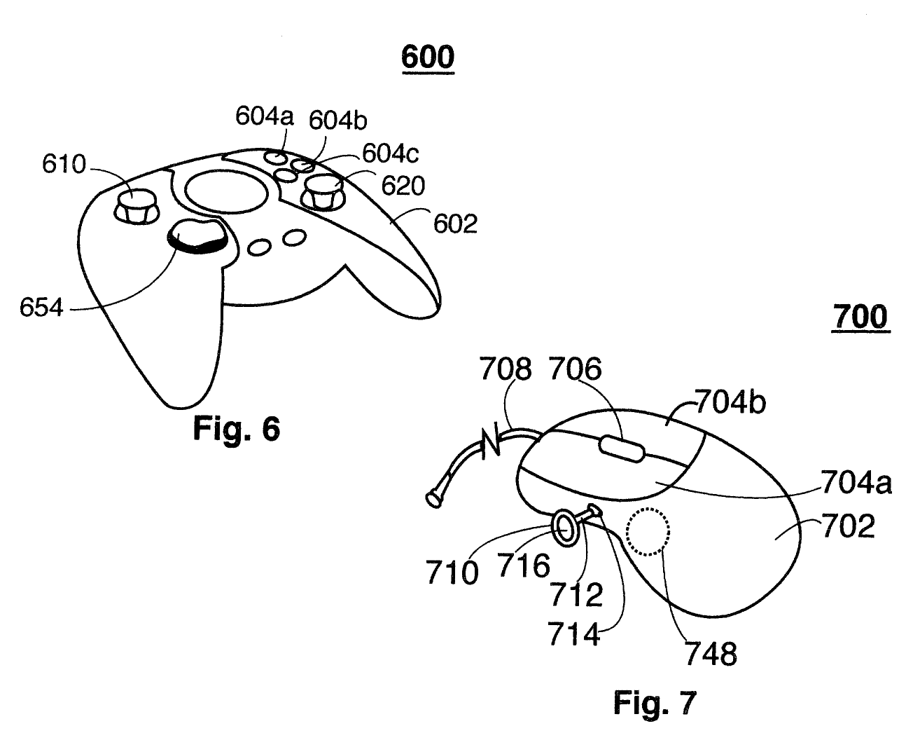

FIG. 13 is a perspective view of an anisometric pointing device 1300 of the same type (i.e., trackball) as illustrated in the embodiment of FIG. 12. Accordingly, the anisometric pointing device 1300 has a housing 1302, a plurality of buttons 1304a, 1304b, 1304c, and a communication means 1308, which, as illustrated, is preferably a cable suitable for transmitting the signal in USB format. A base pointing device mechanism 1348 is a sphere as described with respect to a conventional trackball illustrated in FIG. 3. As illustrated, the base pointing device mechanism 1348 is coupled to a thumb side surfaces for a right handed user, of the housing 1302. Moreover, the anisometric pointing device 1300 has a secondary pointing device mechanism 1344 in the form of a touch pad as discussed with respect to FIG. 4. Because the secondary pointing device mechanism 1344 is coupled to the top surface of the housing 1302, to facilitate such coupling, the top surface of the housing 1302 contains a stable portion 1324 that separates the middle button 1304b from the secondary pointing device mechanism 1344, facilitating selective operation of the button and the secondary pointing device mechanism 1344.

FIG. 14 is a perspective view of an anisometric pointing device 1400 of the same type (i.e., trackball) as illustrated in the embodiment of FIG. 12. Accordingly, the anisometric pointing device 1400 has a housing 1402, a plurality of buttons 1404a, 1404b, and a communication means 1408, which as illustrated, is preferably a cable suitable for transmitting the signal in serial format. A base pointing device mechanism 1448 is a sphere as described with respect to a conventional trackball illustrated in FIG. 3. As illustrated, the base pointing device mechanism 1448 is coupled to a thumb side surface, for a right-handed user, of the housing 1402. Moreover, the anisometric pointing device 1400 has a secondary pointing device mechanism 1420 in the form of a second trackball-roller coupled to the little finger side, for a right-handed user, of the housing 1402. This embodiment of the present invention would have particular utility in many areas, such as, for example, computer assisted drafting, in which manipulation in more than two degrees of freedom is required.

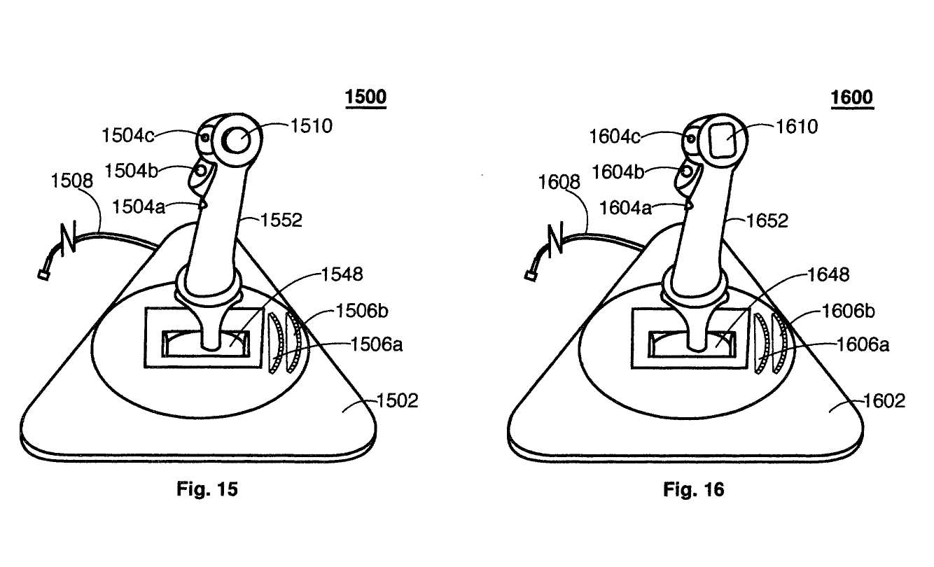

FIG. 15 is a perspective view of yet another embodiment of an anisometric pointing device 1500 in accordance with the principles of the present invention. The base pointing device mechanism 1548 is an anisometric joystick coupling as described with respect to a conventional anisometric joystick illustrated in FIG. 5. Also, as with conventional anisometric joysticks, the anisometric pointing device 1500 includes a vertical stick 1552 coupled to a motionless base 1502; at least one button, with the embodiment illustrated showing three buttons 1504a, 1504b, 1504c; a plurality of sliders 1506a, 1506b coupled to the motionless base 1502; and a communication means 1508 to send a control signal (not shown) to the data processing system. As illustrated in the embodiment of FIG. 15, the communication means 1508 is preferably a cable suitable for transmitting the signal in a USB format. The anisometric pointing device 1500 further includes a secondary pointing device mechanism 1510, which, as illustrated in the embodiment of FIG. 15, is a trackball-roller. Because of its placement, the trackball-roller is most suitable for use by a right-handed user's thumb; however, alternate placements of the secondary pointing device mechanism 1510 may place it in a position suitable for use by another user's digit, for example, to accommodate a disabled user. The secondary pointing device mechanism 1510 can be mapped to perform a unique function, thus increasing the versatility of the anisometric pointing device 1500, or can be mapped to perform the functions associated with the plurality of sliders 1506a, 1506b. Because the secondary pointing device mechanism 1510 is coupled to the vertical stick 1552, can be used independent of the orientation of the vertical stick 1552. A user does not have to use another hand to effect such functionality (as with the sliders 1506a, 1506b), rather, the other hand is free to interact with, for example, a keyboard (not shown). The secondary pointing device mechanism 1510 may also be designed to support movement to actuate a switch, for example, pushing the secondary pointing device mechanism 1510 inwardly has the same effect as manipulating one of the joystick buttons 1504a, 1504b, 1504c. This movement can be mapped to duplicate manipulation of anotherjoystick button, but will preferably be mapped to a unique function, increasing the versatility of the anisometric pointing device 1500 in general.

FIG. 16 is a perspective view of an anisometric pointing device 1600 of the same type (i.e., joystick) as illustrated in the embodiment of FIG. 15. Accordingly, the anisometric pointing device 1600 has a vertical stick 1652 coupled to a motionless base 1602; at least one button, with the example illustrated showing three buttons 1604a, 1604b, 1604c; a plurality of sliders 1606a, 1606b coupled to the motionless base 1602; and a communication means 1608 to send a control signal (not shown) to the data processing system. As illustrated in the embodiment of FIG. 16, the communication means 1608 is preferably a cable suitable for transmitting the signal in a USB format. A base pointing device mechanism 1648 is a coupling as described with respect to a conventional joystick illustrated in FIG. 5. The anisometric pointing device 1600 further includes a secondary pointing device mechanism 1610, which, as illustrated in the embodiment of FIG. 16, is a touch pad as discussed with respect to FIG. 4 above. Because of its placement, the touch pad 1610 is most suitable for use by a right-handed user's thumb; however, alternate placements of the secondary pointing device mechanism 1610 may place it in a position suitable for use by another user's digit, for example, to accommodate a disabled user. The touch pad 1610 can be mapped to perform a unique function, thus increasing the versatility of the anisometric pointing device 1600, or can be mapped to perform the functions associated with the plurality of sliders 1606a, 1606b. Because the touch pad 1610 is coupled to the vertical stick 1652, its use can be used independently of the orientation of the vertical stick 1652, without a user having to use another hand (as with the sliders 1606a, 1606b), which is therefore free to interact with, for example, a keyboard (not shown).

### Base Anisometric, Secondary Isometric

In a second embodiment of the present invention, an anisometric pointing device includes a housing having a plurality of surfaces. The plurality of surfaces includes at least a top surface and a bottom surface, but may also have at least one side surface, a topmost surface, and at least one upper side surface. Because the base device is anisometric, the anisometric pointing device has an anisometric pointing device mechanism for generating a first control signal. Moreover, the device includes at least one isometric pointing device mechanism for generating at least a second control signal. As with the first embodiment of the present invention, the anisometric pointing device mechanism and the at least one isometric pointing device mechanism can be used to manipulate different perspectives within the visual interface of the data processing system, and where appropriate, the positioning of the at least one isometric pointing device mechanism and the physical size of the housing can be such that the anisometric pointing device can be operated by a single hand of the user. Moreover, the at least one isometric mechanism may be moved to actuate a switch, for example, a force applied to the top surface of the at least one isometric pointing device mechanism has the same effect as manipulating a button, providing for yet another functionality that otherwise would not have been available on the anisometric pointing device.

The anisometric pointing device has a communication means for transmitting at least one of the first and the at least a second control signals to a data processing system on which a software application is running. Thus, the anisometric pointing device can be used to input control signals to the software application. The communication means can be a cable, wireless interface, or any means well known in the relevant art. Moreover, the format of the communication protocol can be serial, parallel, USB, PS/2, firewire, or any format well known in the relevant art. The communication means may combine the first control signal and the at least a second control signal into an integrated control signal prior to or subsequent to transmission from the anisometric pointing device if such an integrated control signal is desirable. The integrated control signal can have a structure such that its component control signals maintain their individuality, or alternatively lose that individuality, for example, for processing by a common driver that recognizes only the integrated control signal.

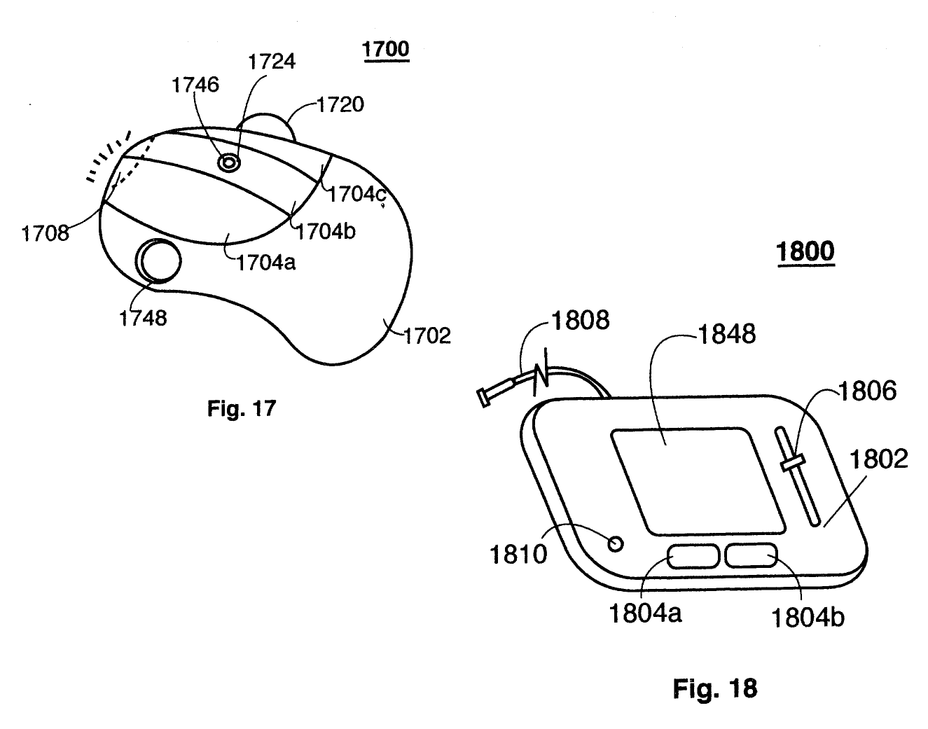

FIG. 17 is a perspective view of an anisometric pointing device 1700 in accordance with the principles of the present invention. A base pointing device mechanism 1748 is a sphere as described above with respect to a conventional trackball illustrated in FIG. 3. As illustrated in this embodiment, the base pointing device mechanism 1748 is coupled to a thumb side surfaces for a right-handed user, of the housing 1702. Also, as with conventional trackballs, the anisometric pointing device 1700 includes at least one button, with the embodiment illustrated showing three buttons 1704a, 1704b, 1704c; and a communication means 1708 to send a control signal (not shown) to the data processing system. As illustrated in the example embodiment of FIG. 17, the communication means 1708 takes the form of a wireless interface suitable for transmitting the signal in a USB format. The anisometric pointing device 1700 further includes a secondary pointing device mechanism 1720 as described above with respect to FIG. 14, and a tertiary pointing device mechanism 1746, which, as illustrated in this embodiment of FIG. 17, is an isometric joystick. The secondary pointing device mechanism 1720 is coupled to the little finger side surfaces for a right-handed user, of the housing 1702, and the tertiary pointing device mechanism 1746 is coupled to the top surface of the housing 1702. The coupling (not shown) of the tertiary pointing device mechanism 1746 may also be designed to support movement for actuating a switch, for example, along the axis defined by the tertiary pointing device mechanism 1746 has the same effect as pushing a button. This movement can be mapped to duplicate pushing of another trackball button, but will preferably be mapped to a unique function, increasing the versatility of the anisometric pointing device 1700 in general. Because the tertiary pointing device mechanism 1746 is coupled to the top surface of the housing 1702, to facilitate such coupling, the top surface of the housing 1702 contains a stable portion 1724 that separates the middle button 1704b from the tertiary pointing device mechanism 1746, facilitating select operation of the button and the tertiary pointing device mechanism 1746.

FIG. 18 is a perspective view of another anisometric pointing device 1800 in accordance with the principles of the present invention. A base pointing device mechanism 1848 configures as a touch pad as described above with respect to a conventional touch pad illustrated in FIG. 4. As with conventional touch pads, the isometric pointing device 1800 includes at least one button, with the example illustrated showing two buttons 1804a, 1804b. Moreover, isometric pointing device 1800 includes a communication means 1808 to send a control signal (not shown) to the data processing system. As illustrated in the example embodiment of FIG. 18, the communication means 1808 is preferably a cable suitable for transmitting the signal in a USB format. The anisometric pointing device 1800 further includes a secondary pointing device mechanism 1810, which, as illustrated in the example embodiment of FIG. 18, is an isometric joystick. The secondary pointing device mechanism 1810 is coupled to the top surface of the housing 1802. The coupling is designed such that the secondary pointing device mechanism 1810 has the ability to be moved in any direction on an XY plane defined by the surface to which the secondary pointing device mechanism 1810 is coupled. The coupling may also be designed to support movement for actuating a switch, for example, along the axis defined by the secondary pointing device mechanism 1810 has the same effect as pushing a touch pad button. This movement can be mapped to duplicate manipulating another touch pad button, but will preferably be mapped to a unique function, increasing the versatility of the anisometric pointing device 1800 in general. The anisometric pointing device 1800, as illustrated, also includes an optional slider 1820 for increased functionality.

It should be noted that, unlike touch pads integrated into the housing of a portable (e.g., laptop) computer, this embodiment of the present invention represents a separate device from that of the data processing system to which it sends control signals. Such a separation facilitates use of the device without interfering with the simultaneous use of the keyboard. However, any embodiment of the present invention could also be embedded in the housing of a data processing system provided that enough distance is provided between the embodiment of the present invention and a keyboard, facilitating simultaneous operation of the two devices.

### Base Isometric, Secondary Anisometric

In a third embodiment of the present invention, an isometric pointing device has the housing with a plurality of surfaces, comprising at least a top surface and a bottom surface, but may also have at least one side surface, a topmost surface, and at least one upper side surface. Because the base device is isometric, the isometric pointing device has an isometric pointing device mechanism for generating a first control signal. Moreover, the device includes at least one anisometric pointing device mechanism for generating at least a second control signal. As with the first embodiment of the present invention, the isometric pointing device mechanism and the at least one anisometric pointing device mechanism can be used to manipulate different perspectives within the visual interface of the data processing system, and where appropriate, the positioning of the at least one anisometric pointing device mechanism and the physical size of the housing can be such that the isometric pointing device can be operated by a single hand of the user. Moreover, the least one anisometric mechanism may be moved to actuate a switch, for example, on the top surface of the at least one anisometric pointing device mechanism has the same effect as pushing a button, providing for yet another functionality that otherwise would not have been available on the isometric pointing device.

The isometric pointing device has a communication means for transmitting at least one of the first control signal and the at least a second control signal to a data processing system on which a software application is running. Thus, the isometric pointing device can be used to input control signals to the software application by way of a cable, wireless interface, or any means well known in the relevant art. Moreover, the format of the communication protocol can be serial, parallel, USB, PS/2, firewire, or any format well known in the relevant art. The communication means may combine the first control signal and the at least a second control signal into an integrated control signal prior to our subsequent to transmission from the anisometric pointing device if such an integrated control signal is desirable. The integrated control signal can have a structure such that its component control signals maintain their individuality, or alternatively lose that individuality, for example, for processing by a common driver that recognizes only the integrated control signal.

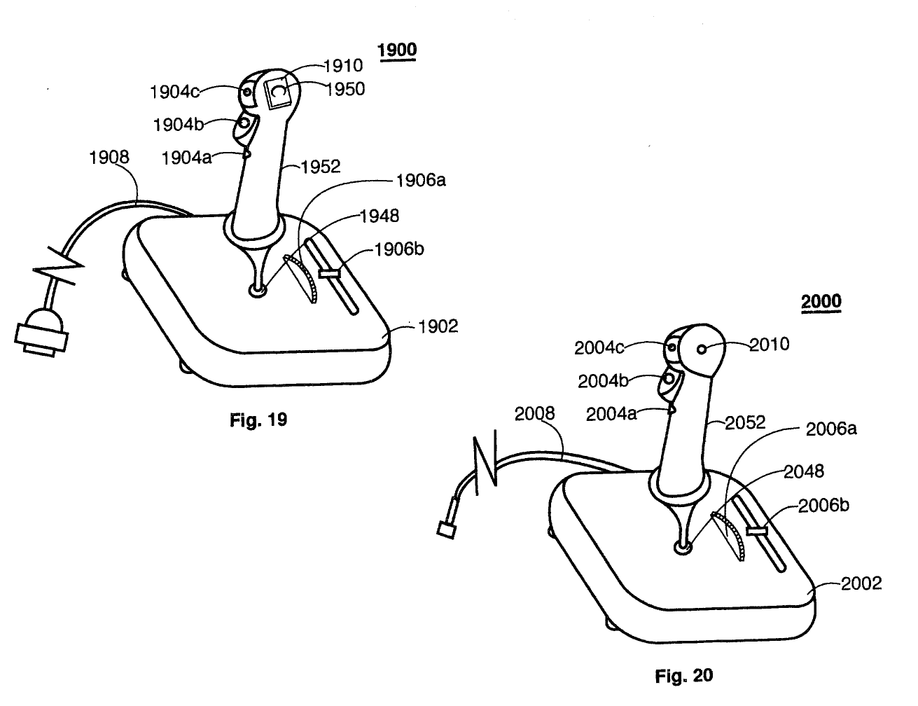

FIG. 19 is a perspective view of an isometric pointing device 1900 in accordance with the principles of the present invention. The base pointing device mechanism 1948 is an isometric joystick coupling as described above with respect to a conventional isometric joystick illustrated in FIG. 4. Also, as with conventional anisometric joysticks, the isometric pointing device 1900 of the present invention includes a vertical stick 1952 coupled to a motionless base 1902; at least one button, with the example illustrated showing three buttons 1904a, 1904b, 1904c; a plurality of sliders 1906a, 1906b coupled to the motionless base 1902; and a communication means 1908 to send a control signal (not shown) to the data processing system. As illustrated in this embodiment of FIG. 19, the communication means 1908 is preferably a cable suitable for transmitting the signal in a parallel format. The isometric pointing device 1900 further includes a secondary pointing device mechanism 1910, which, as illustrated in this embodiment of FIG. 19, is a mouse-type device that slides across the topmost surface of the isometric pointing device 1900, and is optionally held in place by a magnet, wires, or any means (not shown) well known in the relevant art. Alternatively, the secondary pointing device mechanism 1910 may be separate from the housing of the isometric pointing device 1900. To facilitate a return to original position without effecting the visual display (not shown), the secondary pointing device mechanism 1910 includes a ring 1950 through which a user's digit is placed and that can be raised or lowered to prevent the secondary pointing device mechanism 1910 from effecting the visual display of the data processing system. Because of its placement, the secondary pointing device mechanism 1910 is most suitable for use by a right-handed user's thumb; however, alternate placements of the secondary pointing device mechanism 1910 may place it in a position suitable for use by another user's digit, for example, to accommodate a disabled user.

The secondary pointing device mechanism 1910 can be mapped to perform a unique function, thus increasing the versatility of the isometric pointing device 1900, or can be mapped to perform the functions associated with the plurality of sliders 1906a, 1906b. Because the secondary pointing device mechanism 1910 is coupled to the vertical stick 1952, its use is independent of the orientation of the vertical stick 1952, without a user having to use another hand (as with the sliders 1906a, 1906b), which is therefore free to interact with, for example, a keyboard (not shown). The secondary pointing device mechanism 1910 may also be designed to support movement to actuate a switch, for example, pushing in the secondary pointing device mechanism 1910 has the same effect as pushing one of the joystick buttons 1904a, 1904b, 1904c. This movement can be mapped to duplicate manipulation of another joystick button, but will preferably be mapped to a unique function, increasing the versatility of the anisometric pointing device 1900 in general.

### Base Isometric, Secondary Isometric

In a fourth embodiment of the present invention, an isometric pointing device includes a housing with a plurality of surfaces. The plurality of surfaces includes at least a top surface and a bottom surface, but may also have at least one side surface, a topmost surface, and at least one upper side surface. Because the base device is isometric, the isometric pointing device has an isometric pointing device mechanism for generating a first control signal. Moreover, the device includes at least a second isometric pointing device mechanism for generating at least a second control signal. As with the first embodiment of the present invention, the isometric pointing device mechanism and the at least a second isometric pointing device mechanism can be used to manipulate different perspectives within the visual interface of the data processing system, and where appropriate, the positioning of the at least a second isometric pointing device mechanism and the physical size of the housing can be configured such that the isometric pointing device can be operated by a single hand of the user. Moreover, the least a second isometric mechanism may be moved to actuate a switch, for example, such that pushing on the top surface of the at least a second isometric pointing device mechanism has the same effect as pushing a button, providing for yet another functionality that otherwise would not have been available on the isometric pointing device.

The isometric pointing device has a communication means for transmitting at least one of the first control signal and the at least a second control signal to a data processing system on which a software application is running. Thus, the isometric pointing device can be used to input control signals to the software application by way of a cable, wireless interface, or any means well known in the relevant art. Moreover, the format of the communication protocol can be serial, parallel, USB, PS/2, firewire, or any format well known in the relevant art. The communication means may combine the first control signal and the at least a second control signal into an integrated control signal prior to our subsequent to transmission from the anisometric pointing device if such an integrated control signal is desirable. The integrated control signal can have a structure such that its component control signals maintain their individuality, or alternatively lose that individuality, for example, for processing by a common driver that recognizes only. The integrated control signal.

FIG. 20 is a perspective view of yet another an isometric pointing device 2000 in accordance with the principles of the present invention. The base pointing device mechanism 2048 is an isometric joystick coupling as described with respect to a conventional isometric joystick illustrated in FIG. 4. Also, as with conventional anisometric joysticks, the isometric pointing device 2000 includes a vertical stick 2052 coupled to a motionless base 2002; at least one button, with the embodiment illustrated showing three buttons 2004a, 2004b, 2004c; a plurality of sliders 2006a, 2006b coupled to the motionless base 2002; and a communication means 2008 to send a control signal (not shown) to the data processing system. As illustrated in the example embodiment of FIG. 20, the communication means 2008 takes the form of a cable suitable for transmitting the signal in a USB format. The isometric pointing device 2000 further includes a secondary pointing device mechanism 2010, which, as illustrated in the example embodiment of FIG. 20, is an isometric joystick. Because of its placement, the secondary pointing device mechanism 2010 is most suitable for use by a right-handed user's thumb; however, alternate placements of the secondary pointing device mechanism 2010 may place it in a position suitable for use by another user's digit, for example, to accommodate a disabled user. The secondary pointing device mechanism 2010 can be mapped to perform a unique function, thus increasing the versatility of the an isometric pointing device 2000, or can be mapped to perform the functions associated with the plurality of sliders 2006a, 2006b. Because the secondary pointing device mechanism 2010 is coupled to the vertical stick 2052, its use can be used independent of the orientation of the vertical stick 2052, without a user having to use another hand (as with the sliders 2006a, 2006b), which is therefore free to interact with, for example, a keyboard (not shown). The secondary pointing device mechanism 2010 may also be designed to support movement to actuate a switch, for example, pushing in the secondary pointing device mechanism 2010 has the same effect as pushing one of the joystick buttons 2004a, 2004b, 2004c. This movement can be mapped to duplicate manipulation of another joystick button, but will preferably be mapped to a unique function, increasing the versatility of the an isometric pointing device 2000 in general.

### Operation

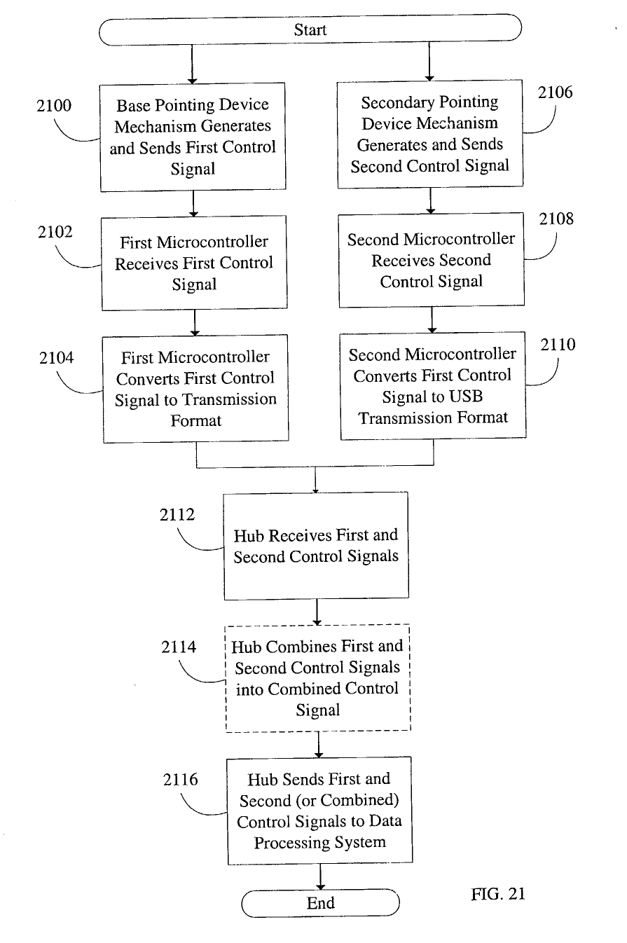

FIG. 21 is a flowchart illustrating the generation, processing, and transmission of control signals from the hybrid pointing device in accordance with the principles of the present invention. At Block 2100, a base pointing device mechanism generates a first control signal indicating that the base pointing device mechanism has received user input. Such input can take the form of, for example, a mouse being rolled across a table surface so that the mouse sphere is moved in a particular direction at a particular speed and acceleration. At Block 2102, a first microcontroller receives the first control signal. The first microcontroller is usually located on a printed control board in the housing of the hybrid pointing device itself, but can be located on a secondary printed control board in a remote device designed to receive wireless transmissions, or anywhere that is well known to be a suitable location in the relevant art. The means for transmitting the first control signal can be by way of cable, wireless interface, or any communication means well known in the relevant art. At Block 2104, the first microcontroller converts the first control signal into a format suitable for transmission of the first control signal to the data processing system. Although USB signal format is the preferred format of communication, any format well known in the relevant art, such as, for example, serial, parallel, PS/2, or firewire, can be used. At Block 2112, a hub receives the first control signal from the first microcontroller.

At Block 2106, a secondary pointing device mechanism generates a second control signal indicating that the secondary pointing device mechanism has received user input. Such input can take the form of, for example, a joystick having its vertical shaft moved in a particular direction so that the resistance of the potentiometer changes. Such signal generation input can, in accordance with the present invention, occur at the same time or at a different time as that generated at Block 2100 with respect to the base pointing device mechanism. At Block 2108, a second microcontroller receives the second control signal. The second microcontroller is usually located on a printed control board in the housing of the hybrid pointing device itself, but can be located on a secondary printed control board, in a remote device designed to receive wireless transmissions, or anywhere that is well known to be a suitable location in the relevant art. The means for transmitting the second control signal can be by way of cable, wireless interface, or any communication means well known in the relevant art, and such means can differ from that of the means for transmitting the first control signal. At Block 2110, the second microcontroller converts the second control signal into a format suitable for transmission of the second control signal to the data processing system. Although USB signal format is the preferred format of communication, any format well known in the relevant art, such as, for example, serial, parallel, PS/2, or firewire, can be used, and such format can differ from that of the format for transmitting the first control signal. At Block 2112, a hub receives the second control signal from the second microcontroller.

At Block 2114, the first and second control signals are, in this embodiment, combined into an integrated control signal so as, for example, to transmit the first and second control signals by way of the same communications means simultaneously. At Block 2116, the hub sends the first and second control signals, whether combined or not, to the data processing system. If not combined, the first and second control signals may be sent simultaneously or alternatively. If alternatively, one signal may be sent in its entirety before the other signal is sent, signal portions can be sent based on an allotted period of time, or by way of any communication medium sharing means well known in the relevant art. It should be noted that, in accordance with the principles of the present invention, the process illustrated by FIG. 21 could additionally include a third (or more) control signals received by a third (or more) microcontroller, which could also optionally be combined into the integrated control signal.

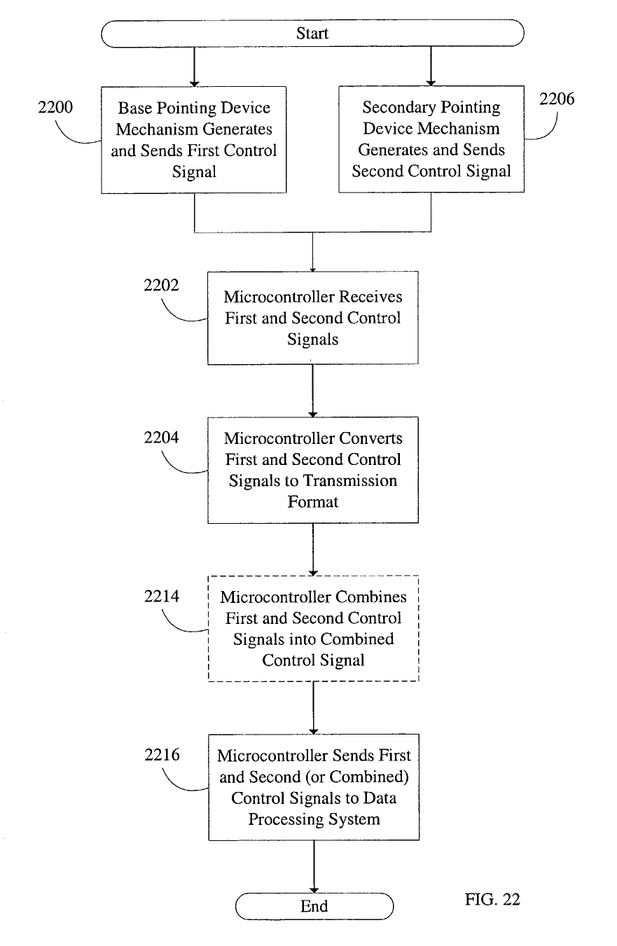

FIG. 22 is a flowchart illustrating an alternate method for the generation, processing, and transmission of control signals from the hybrid pointing device in accordance with the principles of the present invention. At Block 2200, a base pointing device mechanism generates a first control signal indicating that the base pointing device mechanism has received user input. Such input can take the form of, for example, a trackball having its roller moved in a particular direction at a particular speed and acceleration. At Block 2202, a microcontroller receives the first control signal. The microcontroller is usually located on a printed control board in the housing of the hybrid pointing device itself, but can be located on a secondary printed control board, in a remote device designed to receive wireless transmissions, or anywhere that is well known to be a suitable location in the relevant art. The means for transmitting the first control signal can be by way of standard cable, wireless interface, or any communication means well known in the relevant art. At Block 2204, the microcontroller converts the first control signal into a format suitable for transmission of the first control signal to the data processing system. Although USB signal format is the preferred format of communication, any format well known in the relevant art, such as, for example, serial, parallel, PS/2, or firewire, can be used.

At Block 2206, a secondary pointing device mechanism generates a second control signal indicating that the secondary pointing device mechanism has received user input. Such input can take the form of, for example, a touch pad having a user's manipulating digit moved across its surface. Such signal generation input can, in accordance with the present invention, occur at the same time or at a different time as that generated at Block 2200 with respect to the base pointing device mechanism. At Block 2202, the microcontroller receives the second control signal. The means for transmitting the second control signal can be by way of standard cable, wireless interface, or any communication means well known in the relevant art, and such means can differ from that of the means for transmitting the first control signal. At Block 2204, the microcontroller converts the second control signal into a format suitable for transmission of the second control signal to the data processing system. Although USB signal format is the preferred format of communication, any format well known in the relevant art, such as, for example, serial, parallel, PS/2, or firewire, can be used, and such format can differ from that of the format for transmitting the first control signal.

At Block 2214, the first and second control signals are, in this embodiment, combined into an integrated control signal so as, for example, to transmit the first and second control signals by way of the same communications means simultaneously. At Block 2216, the microcontroller sends the first and second control signals, whether combined or not, to the data processing system. If not combined, the first and second control signals may be sent simultaneously or alternatively. If alternatively, one signal may be sent in its entirety before the other signal is sent, signal portions can be sent based on an allotted period of time, or by way of any communication medium sharing means well known in the relevant art. It should be noted that, in accordance with the principles of the present invention, the process illustrated by FIG. 22 could additionally include a third (or more) control signals received by a second (or more) microcontroller, which could also optionally be combined into the integrated control signal.

While the preferred embodiment of the invention have been shown and described, it will be apparent to those skilled in the art that changes and modifications may be made therein without departing from the spirit of the invention, the scope of which is defined by the appended claims. For example, other, unenumerated pointing devices mechanisms not listed may be used as secondary pointing device mechanisms. Also, other combinations of pointing device mechanisms not specifically illustrated or discussed may be used, and although the devices described are for right-handed users, devices with a left-handed bias also may be used. Moreover, other, unenumerated means and formats for communication of control signals may be used. It is therefore contemplated that the present invention cover any and all modifications, variations, or equivalents that fall within the sphere and scope of the basic underlying principles claimed herein.

What is claimed is:

1. An anisometric pointing device for manipulating a visual interface of a data processing system comprising:
a housing including a plurality of surfaces defined on the housing including at least one surface selected from the group consisting of a top surface, a bottom surface, and at least one side surface;
a plurality of control mechanisms including a first anisometric mechanism for generating a first control signal; and at least a second anisometric mechanism for generating at least a second control signal; and
a communication means for transmitting at least one of the first and the at least a second control signals to the data processing system.

2. The anisometric pointing device of claim 1 wherein the first anisometric mechanism and the at least a second anisometric mechanism are different mechanisms.

3. The anisometric pointing device of claim 1 wherein the first anisometric mechanism and the at least a second anisometric mechanism manipulate different perspectives within the visual interface of the data processing system.

4. The anisometric pointing device of claim 1 wherein the first anisometric mechanism and the at least a second anisometric mechanism manipulate perspectives for different elements within the visual interface of the data processing system.

5. The anisometric pointing device of claim 1 wherein the first anisometric mechanism is a mouse; and wherein the plurality of control mechanisms further includes at least a second anisometric mechanism selected from the group consisting of an analog joystick, a digital joystick, and a touch pad.

6. The anisometric pointing device of claim 1 wherein the first anisometric mechanism is a trackball-roller.

7. The anisometric pointing device of claim 1 wherein the first anisometric mechanism is a touch pad.

8. The anisometric pointing device of claim 1 wherein the first anisometric mechanism is at least one of an analog joystick and a digital joystick; and wherein the plurality of surfaces further includes: a topmost surface and at least one upper side surface.

9. The anisometric pointing device of claim 1 wherein the at least a second anisometric mechanism is a mouse.

10. The anisometric pointing device of claim 1 wherein the at least a second anisometric mechanism is a trackball-roller.

11. The anisometric pointing device of claim 1 wherein the at least a second anisometric mechanism is a touch pad.

12. The anisometric pointing device of claim 1 wherein the at least a second anisometric mechanism is at least one of an analog joystick and a digital joystick.

13. The anisometric pointing device of claim 1 wherein the first anisometric mechanism and the at least a second anisometric mechanism may be manipulated by a single hand of a user.

14. The anisometric pointing device of claim 1 wherein the communication means is a cable.

15. The anisometric pointing device of claim 1 wherein the communication means is a wireless interface.

16. The anisometric pointing device of claim 1 wherein at least one of the first control signal and the at least a second control signal are in a USB format.

17. The anisometric pointing device of claim 1 wherein the at least a second anisometric mechanism is connected to the at least one side surface of the housing.

18. The anisometric pointing device of claim 1 wherein the at least a second anisometric mechanism is connected to the top surface of the housing.

19. The anisometric pointing device of claim 1 wherein the at least a second anisometric mechanism may be moved to actuate a switch.

20. The anisometric pointing device of claim 1 wherein the housing is configured to facilitate full range of motion for the at least a second anisometric mechanism.

21. The anisometric pointing device of claim 1 wherein the housing is configured to facilitate use of the plurality of control mechanisms.

22. The anisometric pointing device of claim 1 wherein the first control signal and the at least a second control signal are combined into an integrated control signal.

23. The anisometric pointing device of claim 22 wherein the first control signal and the at least a second control signal lose their individuality.

24. A method for manipulating a visual interface of a data processing system with an anisometric pointing device comprising the steps of:
using a first anisometric mechanism to generate a first control signal;
using at least a second anisometric mechanism to generate at least a second control signal; and
using a communication means to transmit at least one of the first and the at least a second control signals to the data processing system.

25. The method of claim 24 wherein the first anisometric mechanism and the at least a second anisometric mechanism are different mechanisms.

26. The method of claim 24 wherein the first anisometric mechanism and the at least a second anisometric mechanism manipulate different perspectives within the visual interface of the data processing system.

27. The method of claim 24 wherein the first anisometric mechanism and the at least a second anisometric mechanism are used to manipulate perspectives of different elements within the visual interface of the data processing system.

28. The method of claim 24 wherein the first anisometric mechanism is a mouse; and wherein the anisometric pointing device further includes at least a second anisometric mechanism selected from the group consisting of an analog joystick, a digital joystick, and a touch pad.

29. The method of claim 24 wherein the first anisometric mechanism is a trackball-roller.

30. The method of claim 24 wherein the first anisometric mechanism is a touch pad.

31. The method of claim 24 wherein the first anisometric mechanism is at least one of an analog joystick and a digital joystick; and wherein the anisometric pointing device further includes a housing having plurality of surfaces with the surfaces selected from the group consisting of a topmost surface and at least one upper side surface.

32. The method of claim 24 wherein the at least a second anisometric mechanism is a mouse.

33. The method of claim 24 wherein the at least a second anisometric mechanism is a trackballroller.

34. The method of claim 24 wherein the at least a second anisometric mechanism is a touch pad.

35. The method of claim 24 wherein the anisometric pointing device further includes at least a second anisometric mechanism selected from the group consisting of an analog joystick and a digital joystick.

36. The method of claim 24 wherein the using an anisometric mechanism and the using at least a second anisometric mechanism steps are executed with a single hand of a user.

37. The method of claim 24 wherein the communication means is a cable.

38. The method of claim 24 wherein the communication means is a wireless interface.

39. The method of claim 24 wherein at least one of the first control signal and the at least a second control signal is in a USB format.

40. The method of claim 24 wherein the at least a second anisometric mechanism is connected to at least one side surface of the housing.

41. The method of claim 24 wherein the at least a second anisometric mechanism is connected to a top surface of the housing.

42. The method of claim 24 further including the step of moving the at least a second anisometric mechanism to actuate a switch.

43. The method of claim 24 further including the step of combining the first control signal and the at least a second control signal into an integrated control signal.

44. The method of claim 43 wherein the first control signal and the at least a second control signal lose their individuality.

45. An anisometric pointing device for manipulating a visual interface of a data processing system comprising:
a housing including a plurality of surfaces defined as the housing including at least one surface selected from the group consisting of a top surface, a bottom surface, and at least one side surface;
a plurality of control mechanisms including:
an anisometric mechanism for generating a first control signal, wherein the anisometric mechanism is not a mouse; and
at least one isometric mechanism for generating at least a second control signal; and
a communication means for transmitting at least one of the first and the at least a second control signals to the data processing system.

46. The anisometric pointing device of claim 45 wherein the anisometric mechanism and the at least one isometric mechanism manipulate different perspectives within the visual interface of the data processing system.

47. The anisometric pointing device of claim 45 wherein the anisometric mechanism and the at least one isometric mechanism manipulate perspectives of different elements within the visual interface of the data processing system.

48. The anisometric pointing device of claim 45 wherein the anisometric mechanism is a trackball-roller.

49. The anisometric pointing device of claim 45 wherein the anisometric mechanism is a touch pad.

50. The anisometric pointing device of claim 45 wherein the plurality of control mechanisms further includes anisometric mechanism selected from the group consisting of an analog joystick and a digital joystick.

51. The anisometric pointing device of claim 45 wherein the at least one isometric mechanism is at least one of an analog joystick and a digital joystick.

52. The anisometric pointing device of claim 45 wherein the anisometric mechanism and the at least one isometric mechanism may be manipulated with a single hand of a user.

53. The anisometric pointing device of claim 45 wherein the communication means is a cable.

54. The anisometric pointing device of claim 45 wherein the communication means is a wireless interface.

55. The anisometric pointing device of claim 45 wherein at least one of the first control signal and the at least a second control signal are in a USB format.

56. The anisometric pointing device of claim 45 wherein the at least one isometric mechanism is connected to one of the plurality of surfaces of the housing.

57. The anisometric pointing device of claim 45 wherein the at least one isometric mechanism may be moved to actuate a switch.

58. The anisometric pointing device of claim 45 wherein the housing is configured to facilitate a full range of motion for the at least one isometric mechanism.

59. The anisometric pointing device of claim 45 wherein the housing is configured to facilitate use of the plurality of control mechanisms.

60. The anisometric pointing device of claim 45 wherein the first control signal and the at least a second control signal are combined into an integrated control signal.

61. The anisometric pointing device of claim 60 wherein the first control signal and the at least a second control signal lose their individuality.

62. A method for manipulating a visual interface of a data processing system with an anisometric pointing device comprising the steps of:
using an anisometric mechanism to generate a first control signal, wherein the anisometric mechanism is not a mouse;
using at least one isometric mechanism to generate at least a second control signal; and
using a communication means to transmit at least one of the first and the at least a second control signals to the data processing system.

63. The method of claim 62 wherein the anisometric mechanism and the at least one isometric mechanism manipulate different perspectives within the visual interface of the data processing system.

64. The method of claim 62 wherein the anisometric mechanism and the at least one isometric mechanism manipulate perspectives of different elements within the visual interface of the data processing system.

65. The method of claim 62 wherein the anisometric mechanism is a trackball-roller.

66. The method of claim 62 wherein the anisometric mechanism is a touch pad.

67. The method of claim 62 wherein the anisometric mechanism is at least one of an analog joystick and a digital joystick.

68. The method of claim 62 wherein the anisometric pointing device further includes at least one isometric mechanism selected from the group consisting of an analog joystick and a digital joystick.

69. The method of claim 62 wherein the using an anisometric mechanism and the using at least one isometric mechanism steps are executed with a single hand of a user.

70. The method of claim 62 wherein the communication means is a cable.

71. The method of claim 62 wherein the communication means is a wireless interface.

72. The method of claim 62 wherein at least one of the first control signal and the at least a second control signal is in a USB format.

73. The method of claim 62 wherein the at least one isometric mechanism is connected to one of the plurality of surfaces of the housing.

74. The method of claim 62 further including the step of moving at least one isometric mechanism to actuate a switch.

75. The method of claim 62 further including the step of combining the first control signal and the at least a second control signal into an integrated control signal.

76. The method of claim 75 wherein the first control signal and the at least a second control signal lose their individuality.

77. An isometric pointing device for manipulating a visual interface of a data processing system comprising:
a housing including a plurality of surfaces defined on the housing further including at least two surfaces selected from the group consisting of a top surface, a bottom surface, and at least one side surface;
a plurality of control mechanisms including an isometric mechanism for generating a first control signal,
wherein the isometric mechanism has a topmost surface and at least one upper side surface; and
at least one anisometric mechanism for generating at least a second control signal;
wherein the isometric mechanism and the at least one anisometric mechanism may be manipulated with a single hand of a user; and
a communication means for simultaneously transmitting the first and second control signals to the data processing system.

78. The isometric pointing device of claim 77 wherein the isometric mechanism and the at least one anisometric mechanism manipulate different perspectives within the visual interface of the data processing system.

79. The isometric pointing device of claim 77 wherein the isometric mechanism and the at least one anisometric mechanism manipulate perspectives of different elements within the visual interface of the data processing system.

80. The isometric pointing device of claim 77 wherein the isometric mechanism is an analog joystick.

81. The isometric pointing device of claim 77 wherein the isometric mechanism is a digital joystick.

82. The isometric pointing device of claim 77 wherein the at least one anisometric mechanism is a mouse.

83. The isometric pointing device of claim 77 wherein the at least one anisometric mechanism is a trackball-roller.

84. The isometric pointing device of claim 77 wherein the at least one anisometric mechanism is a touch pad.

85. The isometric pointing device of claim 77 wherein the at least one anisometric mechanism is at least one of an analog joystick and a digital joystick.

86. The isometric pointing device of claim 77 wherein the isometric mechanism and the at least one anisometric mechanism may be manipulated with a single hand of a user.

87. The isometric pointing device of claim 77 wherein the communication means is a cable.

88. The isometric pointing device of claim 77 wherein the communication means is a wireless interface.

89. The isometric pointing device of claim 77 wherein at least one of the first control signal and the at least a second control signal is in a USB format.

90. The isometric pointing device of claim 77 wherein the at least one anisometric mechanism is connected to at least one of the topmost surface and the at least one upper side surface of the isometric mechanism.

91. The isometric pointing device of claim 77 wherein the at least one anisometric mechanism may be moved to actuate a switch.

92. The isometric pointing device of claim 77 wherein the housing is configured to facilitate full range of motion for the at least a second anisometric mechanism.

93. The isometric pointing device of claim 77 wherein the housing is configured to facilitate use of the plurality of control mechanisms.

94. The isometric pointing device of claim 77 wherein the first control signal and the at least a second control signal are combined into an integrated control signal.

95. The isometric pointing device of claim 94 wherein the first control signal and the at least a second control signal lose their individuality.

96. A method for manipulating a visual interface of a data processing system with an isometric pointing device comprising the steps of:
using an isometric mechanism to generate a first control signal;
using at least one anisometric mechanism to generate at least a second control signal; and
using a communication means to transmit the first and the at least a second control signals to the data processing system.

97. The method of claim 96 wherein the isometric mechanism and the at least one anisometric mechanism manipulate different perspectives within the visual interface of the data processing system.

98. The method of claim 96 wherein the isometric mechanism and the at least one anisometric mechanism manipulate perspectives of different elements within the visual interface of the data processing system.

99. The method of claim 96 wherein the isometric mechanism is an analog joystick.

100. The method of claim 96 wherein the isometric mechanism is a digital joystick.

101. The method of claim 96 wherein the at least one anisometric mechanism is a mouse.

102. The method of claim 96 wherein the at least one anisometric mechanism is a trackballroller.

103. The method of claim 96 wherein the at least one anisometric mechanism is a touch pad.

104. The method of claim 96 wherein the isometric pointing device further includes at least one anisometric mechanism selected from the group consisting of an analog joystick and a digital joystick.

105. The method of claim 96 wherein the using an anisometric mechanism and the using at least one isometric mechanism steps are executed with a single hand of a user.

106. The method of claim 96 wherein the communication means is a cable.

107. The method of claim 96 wherein the communication means is a wireless interface.

108. The method of claim 96 wherein at least one of the first control signal and the at least a second control signal is in a USB format.

109. The method of claim 96 wherein the at least one anisometric mechanism is connected to at least one of a topmost surface and at least one upper side surface of the isometric mechanism.

110. The method of claim 96 further including the step of moving at least one anisometric mechanism to actuate a switch.

111. The method of claim 96 further including the step of combining the first control signal and the at least a second control signal into an integrated control signal.

112. The method of claim 111 wherein the first control signal and the at least a second control signal lose their individuality.
